(19) United States
(12) Patent Application Publication
(10) Pub. No.: US 2013/0298351 A1
(43) Pub. Date: Nov. 14, 2013

(54) ATTACHMENT FOR AIR BLOWER

(71) Applicant: Franco Romito, Whitestone, NY (US)

(72) Inventor: Franco Romito, Whitestone, NY (US)

(21) Appl. No.: 13/891,233

(22) Filed: May 10, 2013

Related U.S. Application Data
(63) Continuation-in-part of application No. 13/613,148, filed on Sep. 13, 2012.
(60) Provisional application No. 61/645,817, filed on May 11, 2012.

(51) Int. Cl. A47L 9/08; A01G 1/12

(52) U.S. Cl. CPC A47L 9/08; A01G 1/125
USPC 15/405; 15/414

(57) ABSTRACT

An attachment for an air blower that enables a nozzle portion to be configured at various angles is provided. The attachment includes an elongated cylindrical portion, a connector portion, a nozzle portion, and an actuating sleeve. The cylindrical portion has a first end and a second end and has a longitudinal axis running therethrough. The connector portion is disposed at the first end of the cylindrical portion and configured to couple the cylindrical portion to an airflow outlet of an air blower. The nozzle portion is disposed at the second end of the cylindrical portion and is configured to direct airflow. The actuating sleeve is rotatably retained at the second end of the cylindrical portion and coupled to the nozzle portion. The actuating sleeve is configured to adjust the nozzle portion at various angles relative to the longitudinal axis of the cylindrical portion when the user rotates the actuating sleeve.

### PRIORITY

This application is a Continuation-In-Part (CIP) application of utility patent application Ser. No. 13/613,148, filed Sep. 13, 2012, entitled “ATTACHMENT FOR AIR BLOWER”, which claims priority on U.S. Provisional Patent Appl. No. 61/645,817, filed May 11, 2012, entitled “ATTACHMENT FOR AIR BLOWER”, the contents of which are hereby incorporated by reference in their entireties.

### BACKGROUND

1. Field

The present disclosure relates generally to air blowers and debris moving apparatuses, and more particularly, an attachment for an air blower that enables a nozzle portion to be configured at various angles.

2. Description of the Related Art

Air blowers are known in art for using high pressure airflow to move debris in the direction of the airflow, e.g., blowing leaves. Conventional air blowers includes portable types, e.g., hand-held or backpack types, and stand-behind push types. Referring to FIG. 1, a conventional backpack air blower 10 is illustrated. The backpack air blower 10 generally includes a housing 12 which contains a motor and fan for generating the high pressure airflow. The high pressure airflow is ducted via an outlet 14 to a flexible tube member 16. The flexible tube member 16 is then further coupled to a releasable attachment 18 for directing the airflow via a nozzle portion 20. A handle 21 is coupled to the flexible tube member 16 to facilitate the directing of the attachment 18 and nozzle portion 20. The handle 21 may further include controls for the air mover to start and stop the fan, to vary the speed of the fan, etc.

Different attachments are configured for different tasks. For example, a linear or straight attachment 18 as shown in FIGS. 1 and 2 is employed for general use, for example, when directing large debris to a predetermined location. However, when trying to direct airflow under an object, for example, a bush, a flower bed, a vehicle, etc., the user must position the attachment 18 to be close to and parallel to the ground, requiring frequent bending. To avoid the frequent bending, FIG. 3 illustrates an attachment 22 with a nozzle portion 24 arranged at a fixed predetermined angle a, for example, about 45 degrees. The attachment 22 enables the user to direct the airflow parallel to the ground without having to bend. Unfortunately, this requires the user to carry at least two different attachments in addition to the backpack air blower. Furthermore, frequent changing of attachments will extend the time required to complete a task, which in a commercial application will increase labor costs.

Therefore, a need exists for an air blower attachment that can complete the above tasks without the need for carrying multiple attachments requiring multiple attachment changes.

### SUMMARY

An attachment for an air blower that enables a nozzle portion of the attachment to be configured at various angles is provided. The attachment of the present disclosure includes a nozzle portion that is configurable to various angles to accomplish various tasks.

According to an aspect of the present disclosure, an attachment for an air blower includes a rigid, elongated cylindrical portion having a first end and a second end, the rigid, elongated cylindrical portion having a longitudinal axis running therethrough; a connector portion disposed at the first end and configured to couple the cylindrical portion to an airflow outlet of an air blower; a nozzle portion disposed at the second end of the cylindrical portion, the nozzle portion configured to direct airflow out of the cylindrical portion; and an actuating member coupled to the nozzle portion, the actuating portion configured to adjust the nozzle portion at various angles relative to the longitudinal axis of the cylindrical portion.

In one aspect, the actuating member is a cylindrical sleeve disposed at the second end of the cylindrical portion, the cylindrical sleeve configured to adjust the nozzle portion when twisted about the cylindrical portion.

In another aspect, the cylindrical portion further includes an angled channel disposed at the second end adjacent the nozzle portion to enable the nozzle portion to be adjusted relative to the longitudinal axis of the cylindrical portion.

In a further aspect, a predetermined range of the angle of the nozzle portion is about 0 degrees to about 90 degrees. It is to be appreciated that this predetermined range is exemplary and not meant to limit the scope of the present disclosure in any manner. A range including any angle from about 0 degrees to about 360 degrees is contemplated to be within the scope of the present disclosure.

In yet another aspect, the actuating member is a cylindrical sleeve disposed at the second end of the cylindrical portion, the cylindrical sleeve configured to adjust the nozzle portion when slid toward the first end of the cylindrical portion. In one aspect, a trigger member is disposed on the cylindrical sleeve adjacent the first end of the cylindrical portion, the trigger member configured to actuate the cylindrical sleeve. In another aspect, a handle is disposed on first end of the cylindrical portion adjacent the trigger member, wherein the handle and trigger member are simultaneously grasped to actuate the cylindrical sleeve.

According to another aspect of the present disclosure, the actuating member of the attachment includes a deflecting member disposed at the second end of the cylindrical portion, the deflecting member configured to direct airflow leaving the nozzle portion at various angles.

In a further aspect, at least one tube is disposed along a length of the cylindrical portion configured to provide a fluid into the airflow leaving the nozzle portion.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a perspective view of an air blower according to the prior art;

FIG. 2 illustrates an attachment for an air blower according to the prior art;

FIG. 3 illustrates another attachment for an air blower according to the prior art;

FIG. 4 illustrates an attachment for an air blower in accordance with an embodiment of the present disclosure;

FIG. 5 illustrates the attachment for an air blower shown in FIG. 4 where a nozzle portion is configured at an adjustable angle in accordance with an embodiment of the present disclosure;

FIG. 6 is an exploded view of the attachment for an air blower shown in FIG. 4;

FIG. 7 illustrates an attachment for an air blower in accordance with another embodiment of the present disclosure;

FIG. 8 illustrates the attachment for an air blower shown in FIG. 7 where a nozzle portion is configured at an adjustable angle in accordance with an embodiment of the present disclosure;

FIG. 9 illustrates an attachment for an air blower in accordance with yet another embodiment of the present disclosure;

FIG. 10 illustrates an attachment for an air blower in accordance with a further embodiment of the present disclosure;

FIG. 11 illustrates the attachment for an air blower shown in FIG. 10 where a nozzle portion is configured at an adjustable angle in accordance with an embodiment of the present disclosure;

FIG. 12 is a partial view of the attachment for an air blower shown in FIG. 10;

FIG. 13 illustrates an attachment for an air blower in accordance with yet another embodiment of the present disclosure;

FIG. 14 illustrates an attachment for an air blower in accordance with another embodiment of the present disclosure;

FIG. 15 illustrates an exploded view of an attachment for an air blower in accordance with yet another embodiment of the present disclosure;

FIG. 16 illustrates a isometric view of the attachment of FIG. 15 with the axis of the nozzle aligned with a longitudinal axis;

FIG. 17 illustrates an isometric view of the attachment of FIG. 15 with the axis of the nozzle tilted with respect to the longitudinal axis;

FIG. 18 illustrates a cross-sectional side view of the attachment of FIG. 15;

FIG. 19 illustrates a portion of the engaging ends of the cylindrical portion and nozzle shown in FIG. 15;

FIG. 20 illustrates the retaining mechanism shown in FIGS. 4-6 in accordance with an embodiment of the present disclosure;

FIG. 21 illustrates a hand held blower comprising the attachment shown in FIGS. 15-19 in accordance with an embodiment of the present disclosure;

FIG. 22 illustrates a walk-behind blower comprising the attachment shown in FIGS. 15-19 in accordance with an embodiment of the present disclosure;

FIG. 23 illustrates a backpack-type blower comprising the attachment shown in FIGS. 15-19 in accordance with an embodiment of the present disclosure; and

FIG. 24 illustrates a lawn trimmer device comprising the attachment shown in FIGS. 15-19 in accordance with an embodiment of the present disclosure.

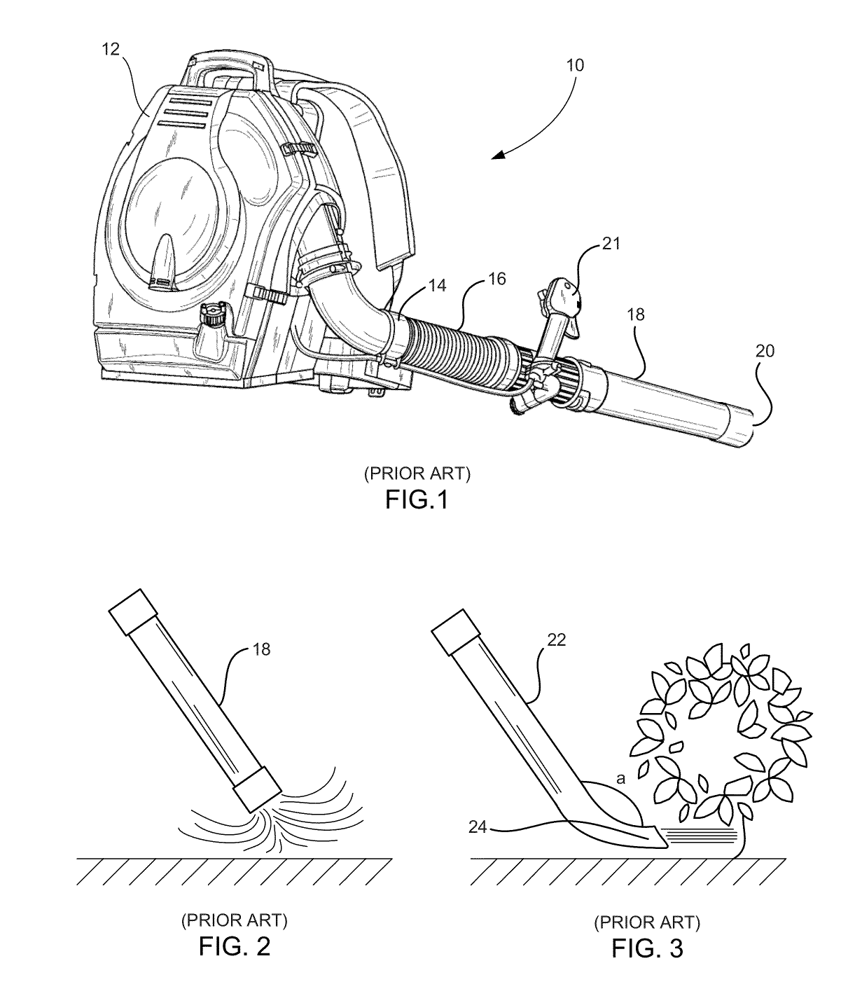

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail.

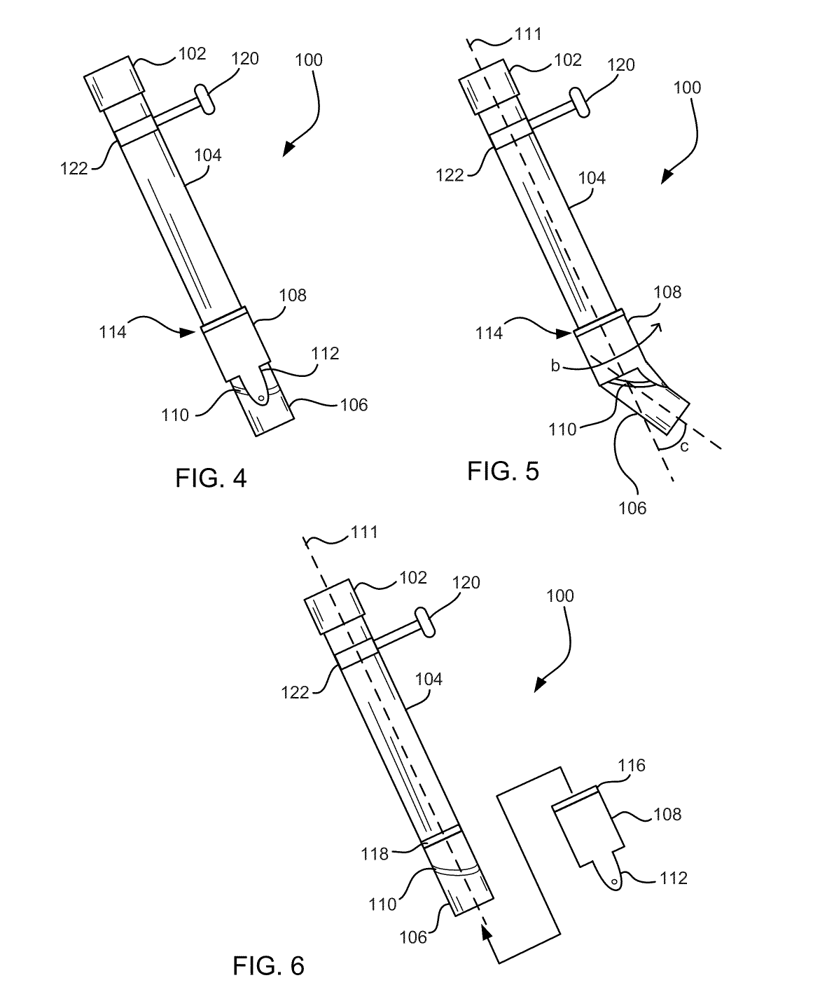

Referring to FIGS. 4-6, an attachment 100 for an air blower in accordance with an embodiment of the present disclosure is illustrated. The attachment 100 includes a connector portion 102 for connecting the attachment 100 to an airflow outlet of an air blower, a rigid, elongated cylindrical portion 104 for conducting airflow and a nozzle portion 106 for directing airflow out of the attachment 100. The attachment 100 further includes an actuating sleeve or member 108 for configuring the nozzle portion 106 at various angles, as will be described in more detail below.

It is to be appreciated that the connector portion 102 may be adapted for connecting the attachment 100 to any various known or to be developed types of air blowers, e.g., hand-held type blowers, backpack type blowers, etc. For example, the connector portion 102 may include a fitting, a snap-fit type connection, an elastic member, etc.

As can be seen most clearly in FIG. 6, an angled channel 110 is formed in the lower section of the rigid cylindrical portion 104 adjacent the nozzle portion 106. The actuating sleeve 108 is disposed over the lower section of the rigid cylindrical portion 104 and coupled to the nozzle portion 106 adjacent the angled channel 110 via a connector 112. It is to be appreciated that the connector may be coupled to the nozzle portion 106 via any known means, for example, a fastener, rivet, bolt, etc.

By providing the angled channel 110 in the lower section of the rigid cylindrical portion 104, the nozzle portion 106 can be configured at various angles (relative to the longitudinal axis 111 of the cylindrical portion 104) by twisting the actuating sleeve 108 in the direction of arrow b. An outer surface of the actuating sleeve 108 may include a gripping or textured surface. The gripping surface may be configured to allow a user to grip the outer surface of the actuating sleeve 108 with the user's hand for manually twisting the actuating sleeve 108. According to the systems of the present disclosure, twisting the actuating sleeve 108 may vary the angle of the nozzle portion 106 in at least a couple different ways. For example, the angle of the nozzle portion 106 may be varied by contorting the nozzle portion 106. In another embodiment, the nozzle portion 106 may be twisted about an angled edge to vary the angle.

In some embodiments in which the nozzle portion 106 is contorted, when the actuating sleeve 108 is rotated, the edge of the nozzle portion 106 in contact with the angled channel 110 remains fixed with the angled channel 110 while other portions of the nozzle portion 106 are twisted with respect to the cylindrical portion 104. The twisting action of the nozzle portion 106 in this respect is configured to temporarily contort or deform the original shape of the nozzle portion 106. In these embodiments, the nozzle portion 106 may comprise flexible material or other material that can be contorted, such as rubber, certain types of plastic, thin metal,

According to other embodiments, the angle of the nozzle portion 106 may be adjusted by having an angled edge at an end of the nozzle portion 106 where the nozzle portion 106 meets the cylindrical portion 104 and an angled edge at an end of the cylindrical portion 104 where the two portions meet. In other words, the angled channels includes, for example, an interlocking channel where the two portions meet enabling them to rotate relative to each other. In this respect, when the nozzle portion 106 is twisted with respect to the cylindrical portion 104, the angle with respect to the longitudinal axis 111 varies because of the angled edges.

As can be seen in FIG. 5, upon twisting the actuating sleeve 108, the connector 112 and angled channel 110 are actuated to configure the nozzle portion 106 at angle c. It is to be appreciated that angle c is adjustable and can be configured from about 0 degrees to about 90 degrees with respect to the longitudinal axis 111. It is to be appreciated that this predetermined range is exemplary and not meant to limit the scope of the present disclosure in any manner. A range including any angle from about 0 degrees to about 360 degrees is contemplated to be within the scope of the present disclosure.

It is further to be appreciated that the angled channel 110 may be configured to completely encircle the lower section of the rigid cylindrical portion 104 (i.e., form a complete circle) or may be formed in just a portion of the cylindrical portion 104. For example, the angled channel 110 may be formed in approximately 50 percent of the circumference of the cylindrical portion 104, i.e., the angled channel does not go all the way around the circumference of the cylindrical portion 104. It is to be appreciated that the angled channel 110 is formed to allow the nozzle portion 106 to be flexed, contorted, gnarled, or deformed relative to the rigid cylindrical portion. As mentioned above, an edge of the nozzle portion 106 connected to the angled channel 110 may remain stationary with respect to the angled channel 110 while other portions of the nozzle portion 106 may twist with respect to the angled channel 110 according to the twisting action of the sleeve 108 on the nozzle portion 106.

In some embodiments, the angled channel 110 can be a flexible material formed between the cylindrical portion 104 and nozzle portion 106. The nozzle portion 106 can also be a flexible material to assist in the flexing action, but in some embodiments may be a rigid material. In this respect, the nozzle portion 106 is able to be pivoted by a contorting action on the angled channel 110. The angled channel 110 may be bellowed to enable movement of the nozzle portion 106.

The actuating sleeve 108 is held on the rigid cylindrical portion 104 by a retaining mechanism 114. In one embodiment, the retaining mechanism 114 includes a tongue and groove arrangement which allows the actuating sleeve 108 to be retained on the rigid cylindrical portion 104 while being twisted. Referring to FIG. 6, the retaining mechanism 114 is constructed by forming a tongue portion 116 on one end of the actuating sleeve 108. A complementary groove portion 118 is formed on the rigid cylindrical portion 104 to receive the tongue portion 116. It is to be appreciated that the tongue and groove portions may be reversed where the tongue portion is on the rigid cylindrical portion 104 and the groove portion is on the actuating sleeve 108. It is further to be appreciated that other retaining mechanism can be employed and are contemplated to be within the scope of the present disclosure. For example, the retaining mechanism 114 may include a depressed channel on the rigid cylindrical portion 104 with at least one complementary protrusion on the actuating sleeve 108 configured to ride within the channel. In another example, the rigid cylindrical portion 104 may include a slot with the actuating sleeve 108 including a finger or other rigid member configured to slide in the slot.

Additionally, the retaining mechanism 114 may include stops to maintain the angle of actuation of the actuating sleeve 108 within a predetermined angle, e.g., from about 0 degrees to about 90 degrees. Using the examples above, the tongue portion 116 and groove portion 118 may be of a predetermined length to limit movement. In the depressed channel and at least one complementary protrusion embodiment, the depressed channel may be of a predetermined length to limit movement of the protrusion riding therein. Similarly, the slot may be of a predetermined length to limit movement of the finger or rigid member riding therein. Other implementations are contemplated to be within the scope of the present disclosure. For example, the retaining mechanism 114 may include at least one detent to set the nozzle portion 106 at a particular angle. The at least one detent provides tactile feedback to a user to indicate the nozzle portion has been set at the particular angle.

In certain embodiments, a handle 120 is provided on an upper end of the rigid cylindrical portion 104 to enable a user to maneuver the attachment 100 when in use. The handle 100 may be coupled to the rigid cylindrical portion 104 via any known means 122 or technique including, but not limited to, a clamp, a bolt, a plastic welding process, etc. It is to be appreciated that the handle can take many forms and shapes. For example, the handle 120 may be configured as a cylindrical member, a curved member, a rectangular prism, etc. or any other shape that would facilitate gripping by a hand of a user.

In use, a user attaches the attachment 100 via the connection portion 102 to the flexible tube member of an air blower. The attachment 100 is then employed as in FIG. 4 to direct air in a linear direction via the nozzle portion 106. As needed, the user can direct airflow in a direction parallel to the ground by simply twisting the actuating sleeve 108 as indicated by arrow b, for example, by gripping the outer surface of the actuating sleeve 108 by hand, resulting in the configuration shown in FIG. 5. The user can return the attachment 100 to the configuration shown in FIG. 4 by simply twisting the actuating sleeve 108 in the reversed direction.

In one embodiment, the connector portion 102, the rigid cylindrical portion 104 and the nozzle portion 106 may be configured as a unitary structure from a similar material. For example, the rigid cylindrical portion 104 and the nozzle portion 106 with the angled channel 110 may be integrally formed from an injection molding process or configured from a single piece of sheet metal. Likewise, the actuating sleeve 108 may be constructed from a similar material as the connector portion 102, the rigid cylindrical portion 104 and the nozzle portion 106. In other embodiment, at least one of the components is constructed from a dissimilar material. In one embodiments, the various components of the attachment 100 may be constructed from plastic, a resin, metal or any other known material that is flexible enough to achieve the techniques described above. Furthermore, the retaining mechanism 114 may be molded, stamped or constructed from various known techniques.

In another embodiment, the connector portion 102, the rigid cylindrical portion 104 and the nozzle portion 106 may be separate parts assembled to form the attachment 100. In one embodiment, the nozzle portion 106 is coupled to the rigid cylindrical portion 104 by the angled channel 110, for example, by crimping, welding or any other known method.

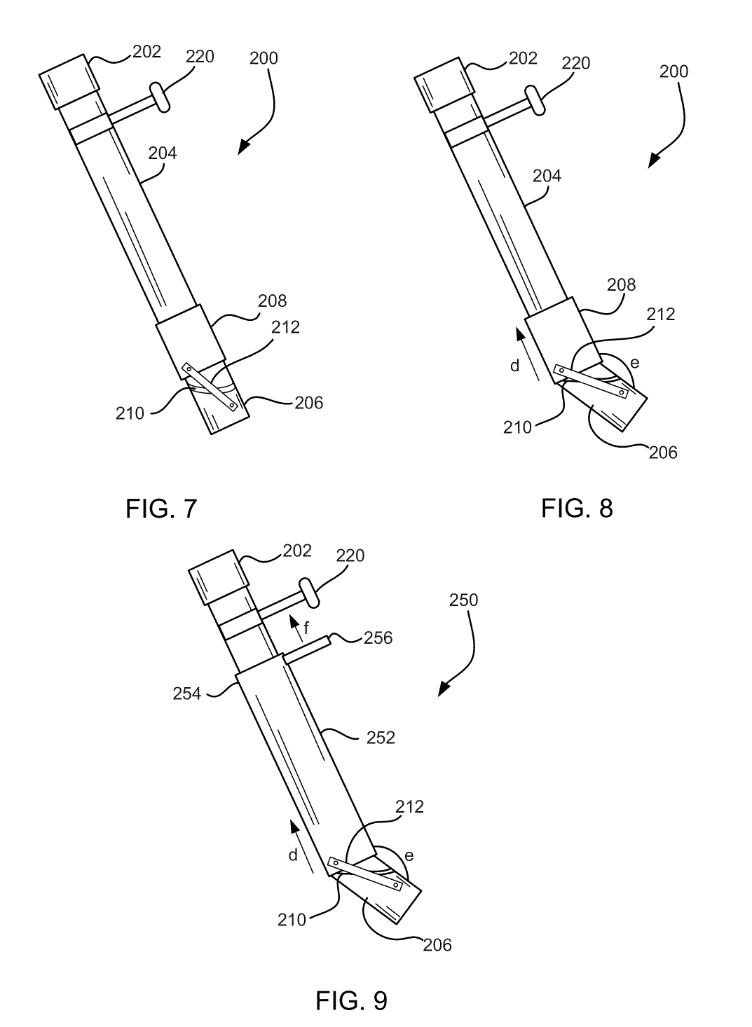

Referring to FIGS. 7-9, an attachment 200 for an air blower in accordance with another embodiment of the present disclosure is illustrated. The attachment 200 includes a connector portion 202 for connecting the attachment 200 to the flexible tube member of an air blower, a rigid cylindrical portion 204 for conducting airflow and a nozzle portion 206 for directing airflow out of the attachment 200. As described above, a handle 220 is provided on an upper end of the rigid cylindrical portion 204 to enable a user to maneuver the attachment 200 when in use. The attachment 200 further includes an actuating sleeve 208 for configuring the nozzle portion 206 at various angles.

An angled channel 210 is formed in the lower section of the rigid cylindrical portion 204 adjacent the nozzle portion 206. The actuating sleeve 208 is disposed over the lower section of the rigid cylindrical portion 204 and coupled to the rigid cylindrical portion 204 adjacent the angled channel 210 via a connector 212. It is to be appreciated that the connector 212 may take the form of a rod, flat rectangular member, etc. It is further to be appreciated that the connector may be coupled to the rigid cylindrical portion 204 and nozzle portion 206 via any known means, for example, a fastener, rivet, bolt, etc. The actuating sleeve 208 is held on the rigid cylindrical portion 204 by a connector 212.

By providing the angled channel 210 in the lower section of the rigid cylindrical portion 204, the nozzle portion 206 can be configured at various angles by sliding the actuating sleeve 208 in the direction of arrow d. It is to be appreciated that the angled channel may be configured in accordance with at least the various embodiments described above. As can be seen in FIG. 8, upon sliding the actuating sleeve 208, the connector 212 and angled channel 210 are actuated to configure the nozzle portion 206 at angle e. It is to be appreciated that angle e is adjustable and can be configured from about 0 degrees to about 90 degrees. It is to be appreciated that other angles are contemplated to be within the scope of the present disclosure.

Referring to FIG. 9, another embodiment of an attachment 250 for an air blower is illustrated. Similar to the attachment 200 shown in FIG. 8, the attachment 250 includes actuating sleeve 252. In this embodiment, the actuating sleeve 252 is of a greater length than sleeve 208, e.g., the actuating sleeve 252 is approximately ⅔ the size of the cylindrical portion 204, while other sizes are contemplated. An upper end 254 of the actuating sleeve 252 extends to an area adjacent handle 220 to facilitate actuation and directing of the nozzle portion 206. Optionally, a trigger member 256 is provided at the upper end 254 of the actuating sleeve 252. In use, a user may simultaneously grasp the handle 220 and trigger member 256 causing the trigger member 256 to move in the direction of arrow f towards the handle 220 and actuating the sleeve 252 in direction of arrow d. Upon actuation of the trigger member 256, the nozzle portion 206 is configured in various angles. It is to be appreciated that the actuating sleeve 256 may be spring biased to return the nozzle portion to its normal state (i.e., angle e of 0 degrees or linear flow) upon release of the trigger member.

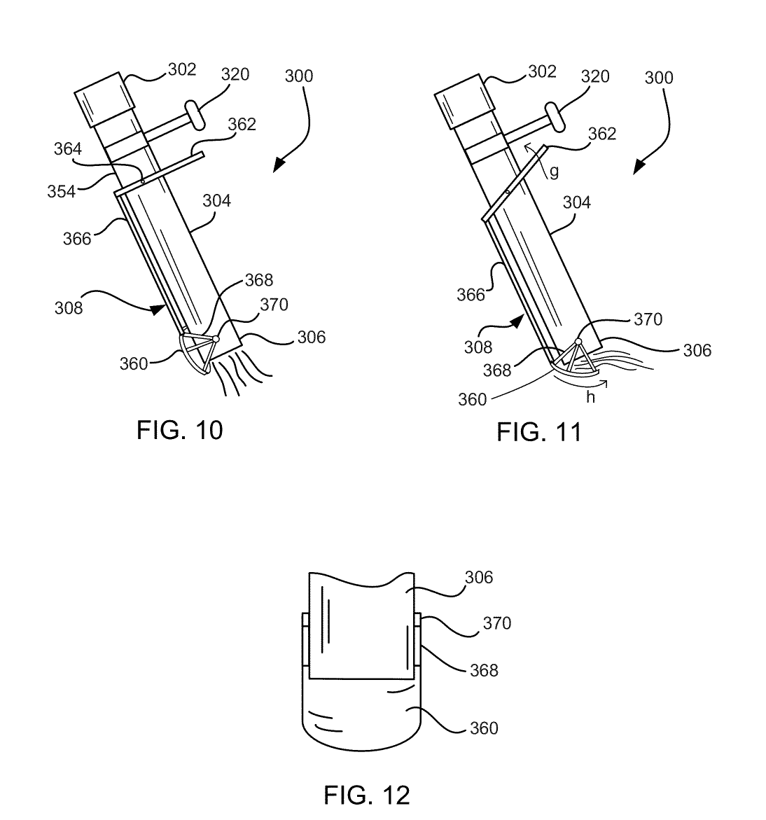

Referring to FIGS. 10-12, an attachment 300 for an air blower in accordance with another embodiment of the present disclosure is illustrated. The attachment 300 includes a connector portion 302 for connecting the attachment 300 to the flexible tube member of an air blower, a rigid cylindrical portion 304 for conducting airflow and a nozzle portion 306 for directing airflow out of the attachment 300. As described above, a handle 320 is provided on an upper end of the rigid cylindrical portion 304 to enable a user to maneuver the attachment 300 when in use. The attachment 300 further includes deflecting member 360 for directing airflow leaving the nozzle portion 306 at various angles.

The deflecting member 360 is coupled to an actuating mechanism 308 for moving the deflecting member 360 in the airflow leaving the nozzle portion 306. In one position, the deflecting member 360 does not interfere with the airflow leaving the nozzle portion as shown in FIG. 10. After actuation, the deflecting member 360 is moved into the airflow causing the airflow to be directed an angle relative to the cylindrical portion 304. The deflecting member 360 may take various forms and shapes. In one embodiment, the deflecting member is planar, rectangular member. In another embodiment, the deflecting member 360 has an arcuate shape to conform to the shape of the cylindrical member 304 when not in use.

The actuating mechanism 308 includes a trigger member 362 coupled to an upper portion 354 of the cylindrical portion 304 via a rotatable connector 364. The trigger member 362 is coupled to the deflecting member 360 by a rod member or other suitable means 366. The deflecting member 360 is further coupled to the nozzle portion 306 via a bracket 368 and connector 370. Upon moving the trigger member 362 in the direction of arrow g, the rod member 366 causes the deflecting member 360 to rotate about connector 370 in the direction of arrow h. In this manner, the deflecting member 360 moves in the airflow leaving the nozzle portion 306 and directs the airflow at an angle determined by the position of the deflecting member 360. It is to be appreciated that the deflecting member 360 may be spring biased to return the deflecting member 360 to its normal state (i.e., retracted from the airflow leaving the nozzle portion 306) upon release of the trigger member.

In a further embodiment, the attachment of the present disclosure may be configured for applying a fluid with the high pressure air generated by the air blower, e.g., for applying a pesticide. It is to be appreciated that a fluid can be any substance, such as a liquid, gas, powder, etc., that is capable of flowing and that changes its shape at a steady rate when acted upon by a force tending to change its shape. In this embodiment, a tube or channel is provided along the length of the cylindrical portion having an input disposed at the upper end of the cylindrical portion and an output disposed at the lower end of the cylindrical portion adjacent the nozzle portion.

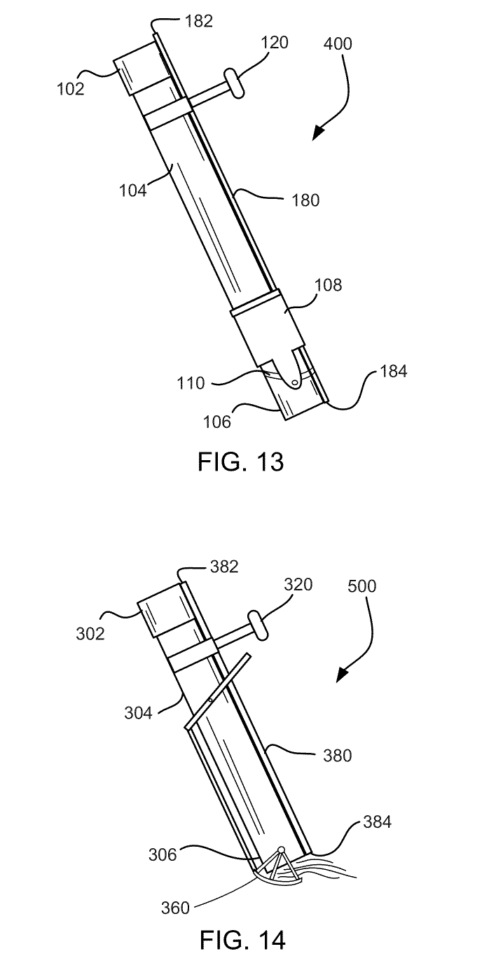

Referring to FIG. 13, an attachment 400 for an air blower configured to apply a fluid is illustrated. Attachment 400 is similar to the embodiment shown in FIGS. 4-6, and therefore, redundant details will not be repeated and similar reference numerals will be employed. Attachment 400 includes a tube or flow channel 180 disposed along the length of cylindrical portion 104. The tube 180 includes an input 182 for receiving a fluid. It is to be appreciated that the input 182 of the tube 180 may be extended to be coupled to a fluid container attached to the air blower. The tube 180 further includes an output 184 disposed adjacent the nozzle portion 106. In this configuration, as fluid is provided to tube 180, the fluid will be dispensed at output 184 into the airflow leaving the nozzle portion 106. It is to be appreciated that the tube 180 is flexible to move with the nozzle portion 106 as it is adjusted. In one embodiment, the tube 180 is integrally formed with the cylindrical portion 104 and nozzle portion 106, e.g., in a molding process.

Referring to FIG. 14, an attachment 500 for an air blower configured to apply a fluid is illustrated. Attachment 500 is similar to the embodiment shown in FIGS. 10-11, and therefore, redundant details will not be repeated and similar reference numerals will be employed. Attachment 500 includes a tube or flow channel 380 disposed along the length of cylindrical portion 304. The tube 380 includes an input 382 for receiving a fluid. It is to be appreciated that the input 382 of the tube 380 may be extended to be coupled to a fluid container attached to the air blower. The tube 380 further includes an output 384 disposed adjacent the nozzle portion 306. In this configuration, as fluid is provided to tube 380, the fluid will be dispensed at output 184 into the airflow leaving the nozzle portion 306. In one embodiment, the tube 180 is integrally formed with the cylindrical portion 104 and nozzle portion 106, e.g., in a molding process.

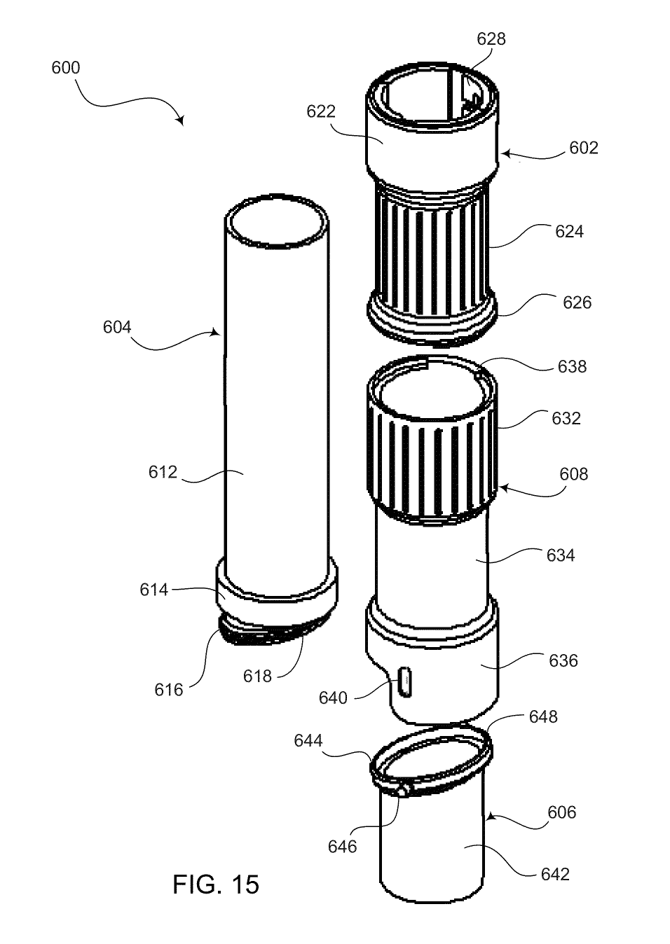

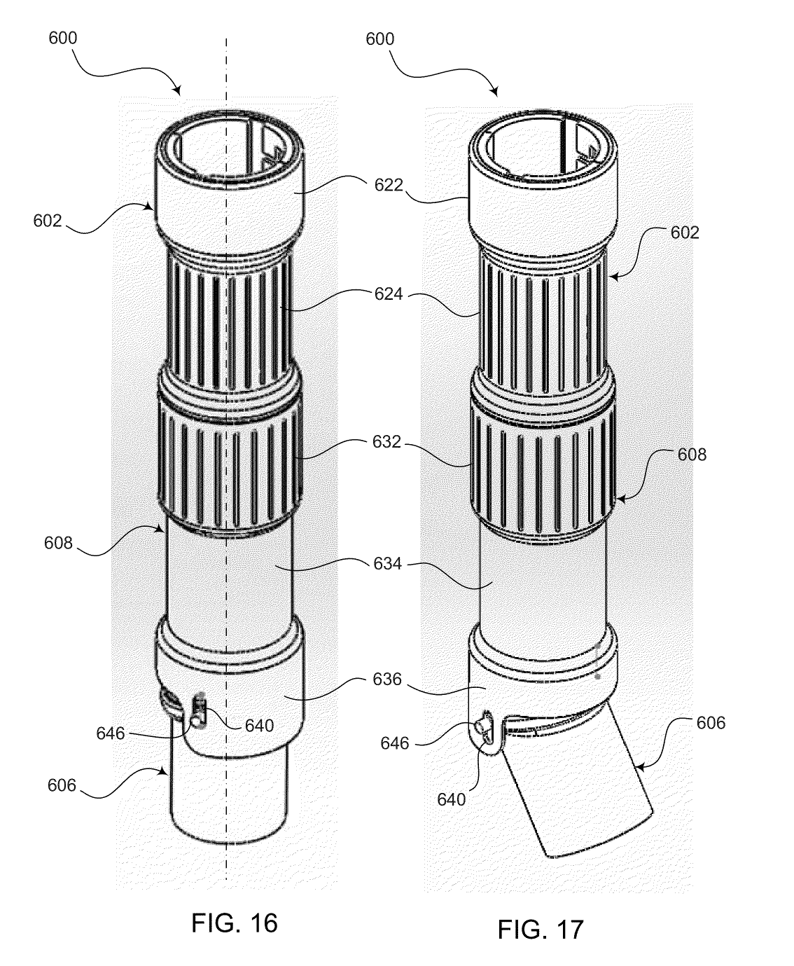

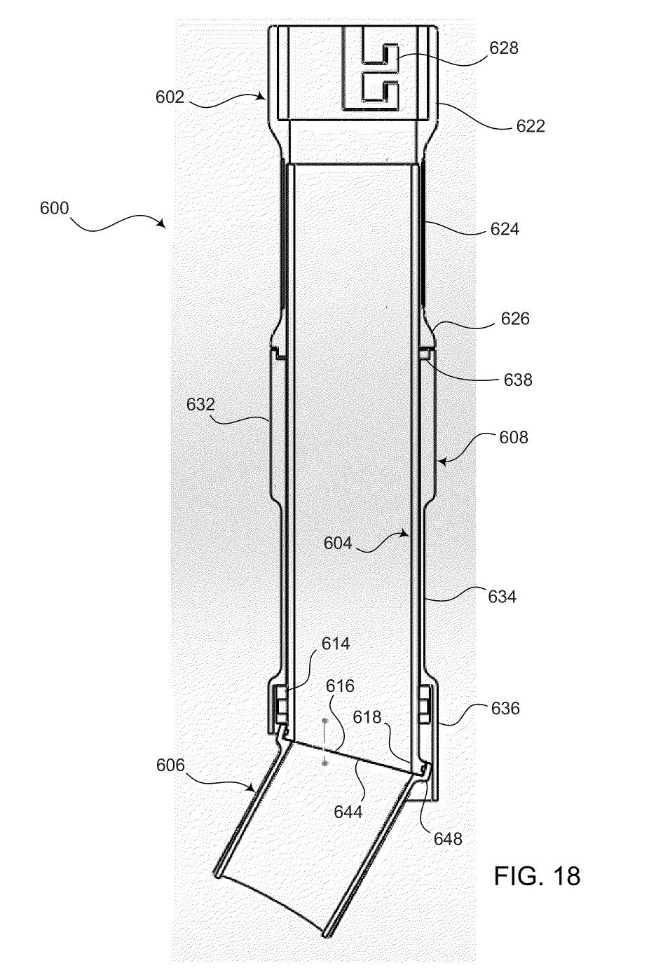

Referring to FIGS. 15-18, an attachment 600 for an air blower in accordance with another embodiment of the present disclosure is illustrated. FIG. 15 shows an exploded view of the attachment 600. FIG. 16 shows an assembled view of the attachment 600 when configured with the elements in alignment with each other. FIG. 17 shows an assembled view of the attachment 600 when then the nozzle is configured at an angle with respect to the other elements. FIG. 18 shows a cross-sectional side view of the attachment 600.

As shown in this embodiment, the attachment 600 comprises four main components, including a cylindrical portion 604, a connector portion 602, a sleeve 608, and a nozzle 606. Each of these components are hollow, cylindrical components. When assembled, the cylindrical portion 604, connector portion 602, and sleeve 608 share a common longitudinal axis 611 (FIG. 16). The nozzle 606 may be configured to be aligned with the longitudinal axis 611 as shown in FIG. 16 or may be adjusted at an angle with respect to the longitudinal axis 611 as shown in FIG. 17.

The connector portion 602 surrounds a top portion of the cylindrical portion 604 and may be fixedly connected to the cylindrical portion 604. When assembled, one end of the nozzle 606 abuts an end of the cylindrical portion 604. The nozzle 606 and cylindrical portion 604 may include any suitable engagement portions to allow the two components to be rotatably connected together. The sleeve 608, when the attachment 600 is assembled, is configured to surround the cylindrical portion 604 and may rotatably engage the connector portion 602. In this respect, the sleeve may be rotated about the axis 611 with respect to the cylindrical portion 604.

The cylindrical portion 604 comprises a tube 612, a ring 614, and angled end 616, and an engagement portion 618. The outside diameter of the tube 612 may be slightly smaller than the inside diameters of the connector portion 602 and sleeve 608 to allow the connector portion 602 and sleeve 608 to surround the cylindrical portion and to allow the sleeve 608 to rotate with respect to the cylindrical portion 604. The angled portion 616 may be formed with any suitable angle with respect to the longitudinal axis 611. The engagement portion 618 is configured to engage with a complementary engagement portion on the nozzle 606.

The connector portion 602 is a cylindrical element comprising a head 622, a body 624, and an end 626. On an inside surface of the connector portion 602, a blower connection lock 628 is formed. The blower connection lock 628 is configured to connect to various types of air blowers, e.g., a hand-held type blower, a backpack type blower, etc. The body 624 may comprise a textured surface to enable the user to grip the connector portion 602 while it is being installed on the air blower. The textured surface may include channels, ridges, or other features to assist with gripping. The end 626 includes an engagement components to connect with the sleeve 608 and to allow the sleeve 608 to rotate. In some embodiments, the engagement components of the end 626 may include stops, protrusions, walls, or other features that cooperate with complementary components of the sleeve 608 to limit the angle at which the sleeve 608 can be rotated.

The sleeve 608 is a cylindrical component comprising a head 632, body 634, and shield 636. The top end of the head 632 includes components for engaging with the connector portion 602 as mentioned above. The end of the head 632, for example, may also include stops 638 or other features for limiting the angle of rotation of the sleeve 608. The sides of the head 632 may include a textured or gripping surface to enable a user to grip the sleeve 608 during rotation of the sleeve 608 about the cylindrical portion 604. The shield 636 is configured to surround parts of the angled end 616 of the cylindrical portion 604 and an angled end of the nozzle 606 when the two ends are engaged. The shield 636 also includes one or more slots 640 formed linearly along a side of the shield 636. The slots 640 are configured to allow limited motion of corresponding pins of the nozzle 606 protruding through the slots 640.

The nozzle 606 is a cylindrical component having a tube 642, an angled end 644, one or more pins 646, and an engagement portion 648. The engagement portion 648 is configured to engage with the corresponding engagement portion 618 of the cylindrical portion 604. The engagement portion 648 allow the nozzle 606 to be rotatably connected with the cylindrical portion. In some embodiments, the engagement portion 648 and/or the engagement portion 618 of the cylindrical portion 604 may contain features, such as stops, to limit the angle of rotation of the nozzle 606 with respect to the cylindrical portion 604.

When the attachment 600 is assembled, as is shown in FIGS. 16 and 17, the pin 646 of the nozzle 606 is configured to protrude through the slot 640. When the sleeve 608 is rotated, the sides of the slots 640 apply pressure to the pins 646, forcing the nozzle 606 to rotate at its angled end 644. When the sleeve 608 is rotated in the opposite direction, the other sides of the slots 640 apply pressure to the pins, forcing the nozzle 606 to rotate in the opposite direction. In this respect, the sleeve 608 and nozzle 606 rotate substantially together. However, because of the angled end 644 of the nozzle 606 and the corresponding angled end 616 of the cylindrical portion 604, the nozzle 606 will also tilt with respect to axis 611 when it is rotated.

FIG. 18 shows a cross-sectional view of the attachment 600 in its assembled form. As shown, the cylindrical portion 604 is arranged inside the connection portion 602 and sleeve 608. The angled end 616 of the cylindrical portion 604 abuts the angled end 644 of the nozzle 606. The shield 636 of the sleeve 608 is arranged around the ring 614 of the cylindrical portion 604 and parts of the angled ends 616, 644. The head 622 of the connector portion 602 includes the blower connection lock 628. As shown in FIG. 18, the blower connection lock 628 includes a channel for receiving complementary elements of the blower.

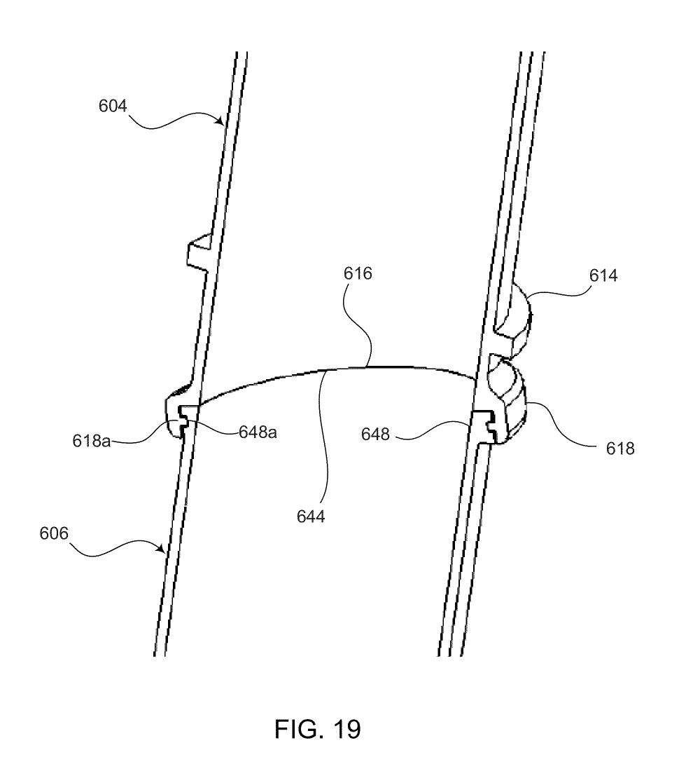

FIG. 19 shows an enlarged portion of the connection between the cylindrical portion 604 and the nozzle 606. The angled end 616 of the cylindrical portion 604 meets the angled end 644 of the nozzle 606 as shown. At this meeting, the two components may comprise any suitable type of slidable connection mechanism. In the illustrated embodiment, the components include a tongue and groove connection, where the tongue is inserted with the groove and is allowed to slidably rotate within the groove. The engagement portion 618 of the cylindrical portion 604 in this embodiment is a tongue 618a and the engagement portion 648 of the nozzle 606 is a groove 648a.

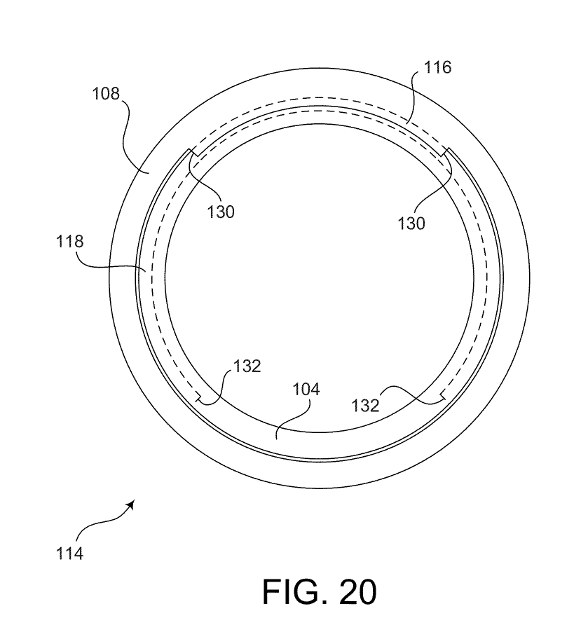

FIG. 20 illustrates a cross-sectional view of an embodiment of the retaining mechanism 114 shown in FIGS. 4-6. As shown, the retaining mechanism 114 includes parts of the actuating sleeve 108 and cylindrical portion 104. The cross-section of the actuating sleeve 108 and cylindrical portion 104 are each circular with a predetermined thickness to provide support. An inner surface of the actuating sleeve 108 is disposed adjacent to an outer surface of the cylindrical portion 104, allowing the actuating sleeve 108 to rotate around the cylindrical portion 104. The outer surface of the cylindrical portion 104 may also include the groove portion 118, which is shown in phantom in FIG. 20. The groove portion 118 is formed below the outer surface of the cylindrical portion 104. Although the groove portion 118 is shown with a depth of about one-half the width of the walls of the cylindrical portion 104, it should be noted that the groove portion 118 in other embodiments may have any suitable depth. The groove portion 118 includes walls or stops 132 and therefore does not extend all the way around the periphery of the cylindrical portion 104 in this embodiment.

Also in FIG. 20, the actuating sleeve 108 may include the tongue portion 116 or protrusion, which extends from the inner surface of the actuating sleeve 108 providing the actuating sleeve 108 with a large width at its location. The tongue portion 116 includes walls or stops 130 and therefore does not extend all the way around the periphery of the actuating sleeve 108 in this embodiment. The tongue portion 116 is fitted within the groove portion 118 to allow the actuating sleeve 108 to rotate around the cylindrical portion 104. When rotated a certain amount in either direction, the stops 132 and 130 prevent the actuating sleeve 108 from rotating beyond a certain point.

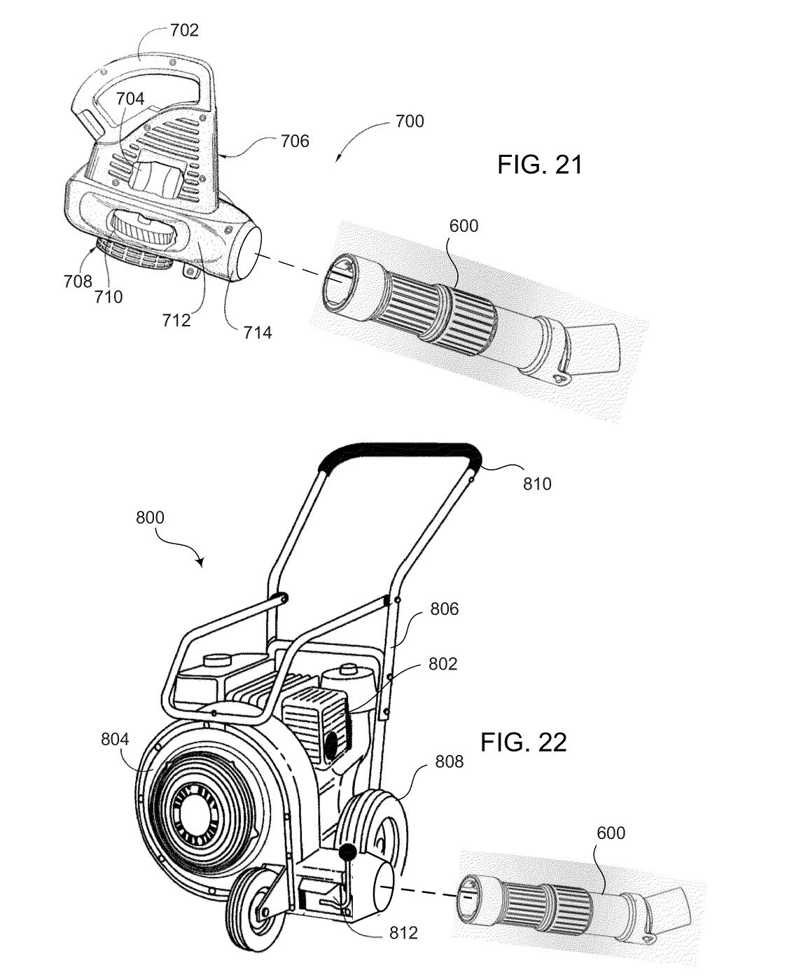

FIG. 21 illustrates an embodiment of a hand held blower 700. In this embodiment, the hand held blower 700 includes a housing 706 and an air flow section 712. The housing 706 includes a handle 702 extending from a top portion to enable the blower 700 to be carried by a user. The housing 706 contains at least a motor 704. The air flow section 712 includes an air inlet 708 that allows air into an impeller 710. Air is pulled into the air flow section 712 by the impeller 710 and expels air through an outlet 714. The outlet 714 is configured with connection features to allow connection to various types of attachments. In this embodiments, attachment 600 is connected to the outlet 714 to direct the air flow out of the hand held blower 700. Other attachments 100, 200, 300, 400, and 500 may also be connected to outlet 714 according to other implementations.

FIG. 22 illustrates an embodiment of a walk-behind blower 800. In this embodiment, the walk-behind blower 800 includes at least a motor 802 and a fan that is contained within a housing 804. The blower 800 also includes a frame 806 for mounting the motor 802 and wheels 808 connected to the frame 806 to allow the blower 800 to be rolled along the ground. A handle 810 allows a user to control the direction where the blower 800 is moved. The blower 800 also contains an air outlet 812 that comprises connection features to allow various attachments to be connected to the blower 800. As shown in FIG. 22, attachment 600, as described in the present disclosure, can be attached to the blower 800. In other embodiments, blower 800 may be configured with one of the other attachments 100, 200, 300, 400, and 500 described herein.

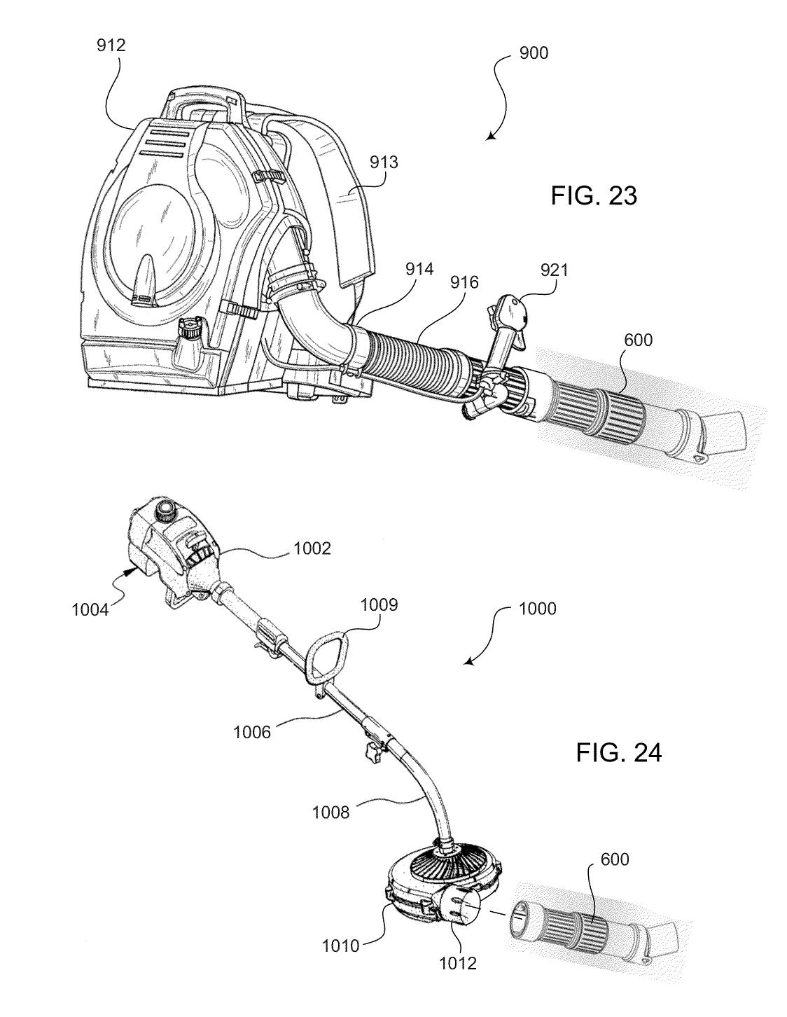

FIG. 23 illustrates an embodiment of a backpack-type blower 900. In this embodiment, backpack-type blower 900 includes a backpack-type housing 912 that contains a motor and a fan for generating an airflow. At least one strap 913 is coupled to the housing 912 to enable a user to carry the portable housing 912 on the back of the user. The blower 900 further includes an outlet 914 that leads to a flexible tube member 916, which is further coupled to an attachment. The blower 900 also includes a handle 921 coupled to the flexible tube member 916 to facilitate the directing of the attachment. The handle 921 may also include controls to vary the speed of the fan housing in the backpack-type housing 912. In the embodiment of FIG. 23, backpack-type blower 900 includes attachment 600 connected to an end of a section that supports the handle 921. In other embodiments, the other attachments 100, 200, 300, 400, and 500 can alternatively be connected to the backpack-type blower 900.

FIG. 24 illustrates an embodiment of a yard trimmer device 1000. In this embodiment, the yard trimmer device 1000 includes a motor housing 1002 and a motor 1004. The yard trimmer device 1000 also includes a straight rod 1006 and a curved rod 1008 connected together and connecting the motor housing 1002 to a fan attachment 1010. A handle 1009 is provided to enable a user to carry the yard trimmer device 1000. The fan attachment 1010 includes an air outlet 1012. The yard trimmer device 1000 may also include another attachment connected to the curved rod 1008 in place of the fan attachment, such as a trimming attachment, edging attachment, or other similar attachments. In this embodiment, the air outlet 1012 of the fan attachment 1010 is connected to the attachment 600, as shown, or may be connected to one of attachments 100, 200, 300, 400, and 500.

The attachments 100, 200, 300, 400, 500, and 600 may be configured with specific connection elements to allow the attachments to be connected to any suitable type of air blower. For example, the attachment be connectable to blowers for landscaping purposes. Landscape blowers may include portable air blowers including backpack-type blowers, handheld blowers, etc. and walk-behind blowers, and other types of blowers. In addition, the attachments discussed herein may also be configured to be attached to other suitable types of air blowers or vacuum machines, such as shop vacuum/blowers, vacuum cleaners, hair dryers, air pumps, etc. In some embodiments, the connection elements may be altered to fit the particular air blower/vacuum and may be scaled as appropriate for the particular type of air blower/vacuum.

It is to be appreciated that the various features shown and described are interchangeable, that is a feature shown in one embodiment may be incorporated into another embodiment.

While the disclosure has been shown and described with reference to certain preferred embodiments thereof, it will be understood by those skilled in the art that various changes in form and detail may be made therein without departing from the spirit and scope of the disclosure.

Furthermore, although the foregoing text sets forth a detailed description of numerous embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

What is claimed is:

1. An attachment for an air blower comprising:
a rigid, elongated cylindrical portion having a first end and a second end, the cylindrical portion having a longitudinal axis running therethrough;
a connector portion disposed at the first end of the cylindrical portion and configured to couple the cylindrical portion to an airflow outlet of an air blower;
a nozzle portion disposed at the second end of the cylindrical portion, the nozzle portion configured to direct airflow out of the cylindrical portion; and
an actuating sleeve rotatably retained at the second end of the cylindrical portion and coupled to the nozzle portion, the actuating sleeve having a gripping surface enabling a user to rotate the actuating sleeve, wherein the actuating sleeve is configured to adjust the nozzle portion at various angles relative to the longitudinal axis of the cylindrical portion when the user rotates the actuating sleeve about the second end of the cylindrical portion.

2. The attachment for an air blower of claim 1, wherein the actuating sleeve is a cylindrical sleeve.

3. The attachment for an air blower of claim 2, wherein the cylindrical sleeve is further coupled to the second end of the cylindrical portion by a retaining mechanism.

4. The attachment for an air blower of claim 3, wherein the retaining mechanism comprises a tongue portion on one end of the actuating sleeve and a complementary groove portion formed in the cylindrical portion, and wherein the tongue portion is configured to slide in the complementary groove portion when the cylindrical sleeve is rotated about the second end of the cylindrical portion.

5. The attachment for an air blower of claim 4, wherein the tongue portion on the actuating sleeve comprise a first edge stop and a second edge stop and the complementary groove portion formed in the cylindrical portion comprises a first wall stop and a second wall stop, the first edge stop configured to engage with the first wall stop when the cylindrical sleeve member is rotated in one direction, and the second edge stop configured to engage with the second wall stop when the cylindrical sleeve member is rotated in the opposite direction.

6. The attachment for an air blower of claim 3, wherein the retaining mechanism includes at least one stop to limit the movement of the cylindrical sleeve and to thereby limit the angle of the nozzle portion to be within a predetermined range.

7. The attachment for an air blower of claim 6, wherein the predetermined range of the angle of the nozzle portion is about 0 degrees to about 90 degrees.

8. The attachment for an air blower of claim 3, wherein the retaining mechanism further comprises at least one detent configured to provide tactile feedback to the user.

9. The attachment for an air blower of claim 1, wherein the cylindrical portion further includes an angled channel disposed at the second end adjacent the nozzle portion to enable the nozzle portion to be adjusted relative to the longitudinal axis of the cylindrical portion.

10. The attachment for an air blower of claim 9, wherein the cylindrical portion, nozzle portion, and angled channel are integrally formed from a single material.

11. The attachment for an air blower of claim 9, wherein the actuating sleeve is configured to contort the nozzle portion about the angled channel when the actuating sleeve is rotated about the second end of the cylindrical portion.

12. The attachment for an air blower of claim 11, wherein the actuating sleeve contorts the nozzle portion to adjust the nozzle portion at various angles relative to the longitudinal axis of the cylindrical portion.

13. An air blower assembly comprising:
an air blower including a motor and fan configured for generating high pressure airflow, the motor and fan disposed in a portable housing having an airflow outlet, the portable housing configured to be carried by a user;
a flexible tube member coupled to the airflow outlet; and
an attachment comprising:
a rigid, elongated cylindrical portion having a first end and a second end, the cylindrical portion having a longitudinal axis running therethrough;
a connector portion disposed at the first end of the cylindrical portion and configured to couple the cylindrical portion to an airflow outlet of an air blower;
a nozzle portion disposed at the second end of the cylindrical portion, the nozzle portion configured to direct airflow out of the cylindrical portion; and
an actuating sleeve rotatably retained at the second end of the cylindrical portion and coupled to the nozzle portion, the actuating sleeve having a gripping surface enabling a user to rotate the actuating sleeve,
wherein the actuating sleeve is configured to adjust the nozzle portion at various angles relative to the longitudinal axis of the cylindrical portion when the user rotates the actuating sleeve about the second end of the cylindrical portion.

14. The air blower assembly of claim 13, wherein the actuating sleeve is coupled to the second end of the cylindrical portion by a retaining mechanism.

15. The air blower assembly of claim 14, wherein the retaining mechanism comprises a tongue portion on one end of the actuating sleeve and a complementary groove portion formed in the cylindrical portion, and wherein the tongue portion is configured to slide in the complementary groove portion when the cylindrical sleeve is rotated about the second end of the cylindrical portion.

16. The air blower assembly of claim 14, wherein the retaining mechanism includes at least one stop to limit the movement of the cylindrical sleeve and to thereby limit an angle of the nozzle portion to a range of about 0 degrees to about 90 degrees.

17. The air blower assembly of claim 13, wherein the cylindrical portion further includes an angled channel disposed at the second end adjacent the nozzle portion to enable the nozzle portion to be adjusted relative to the longitudinal axis of the cylindrical portion.

18. The air blower assembly of claim 17, wherein the cylindrical portion, nozzle portion, and angled channel are integrally formed from a single material.

19. The air blower assembly of claim 17, wherein the actuating sleeve is configured to contort the nozzle portion about the angled channel when the actuating sleeve is rotated about the second end of the cylindrical portion.

20. The air blower assembly of claim 19, wherein the actuating sleeve contorts the nozzle portion to adjust the nozzle portion at various angles relative to the longitudinal axis of the cylindrical portion.
